(19) United States
(12) Patent Application Publication
(10) Pub. No.: US 2007/0029096 A1
(43) Pub. Date: Feb. 8, 2007

(54) Locking-releasing head for a powder fire extinguisher

(76) Inventors: Boris Konstantinovich Zuev, Samara (RU); Anatoly Semenovich Batanov, Samara (RU)

Correspondence Address: LADAS & PARRY, 26 WEST 61ST STREET, NEW YORK, NY, 10023, US

(21) Appl. No.: 10/544,981

(22) PCT Filed: Feb. 27, 2003
(86) PCT No.: PCT/RU03/00067

§ 371 Date: Sep. 15, 2006

(51) Int. Cl. A62C 11/00; A62C 13/00; A62C 35/58

(52) U.S. Cl. 169/30; 169/72; 169/88

(57) ABSTRACT

The inventive locking-releasing head is designed for pumped powder fire extinguishers which eject a fire extinguishing powder at a positive pressure and can be used as primary fire extinguishing means for fighting fires of class A (solid substances), class B (liquid substances) and class C (gaseous substances), fires of electrical installations when at voltage of up to 1000 V as well as fires at road, railway and river transport.

Said locking-releasing head for a powder fire extinguisher comprises a body (1) provided with elements for fixing to the container of said fire extinguisher, a handle connected to the body (1), a locking unit provided with a rod (16) carrying a valve fixed thereto, a control lever (13), a siphon tube (21), a pressure indicator (2) and a spraying nozzle (19). Said pressure indicator (2) is arranged on the valve rod (16) in which rod (16) a hole is provided to communicate the under-membrane cavity of the indicator with the under-valve cavity of the head. The inventive structural design ensures high technical and economic characteristics, keeps pressure for a long time and makes it possible to carry out an impulse operation mode.

### FIELD OF THE INVENTION

The invention relates to fire-fighting equipment, and namely, to locking-releasing heads for pumped powder fire extinguishers which eject a fire extinguishing powder at a positive pressure and can find application as primary fire extinguishing means for fighting fires of class A (solid substances), class B (liquid substances) and class C (gaseous substances), fires of electrical installations when at voltage of up to 1000 V as well as fires at road, railway and river transport.

### DESCRIPTION OF THE PRIOR ART

A hand-held fire extinguisher is known in prior art to comprise a bottle with a locking unit mounted thereto and having a spring-loaded valve with a rod on which a pressure indicator is arranged to be disposed that is made as a flag. A siphon tube is mounted freely, an arresting stop is made as a ring, and a piston is arranged to be disposed at the upper end of the siphon tube where it is in contact with the valve (SU 607576 A, 25.04.1978).

When the fire extinguisher is being pumped up, pressure increases inside the bottle, and the siphon tube that is connected with the piston, rises upwards until it gets seated against the end face of the valve, whereupon it compresses the valve spring to bring the valve to a predetermined height so that the bottle gets locked thereby and the flag stops against a predetermined mark to indicate the pressure inside the bottle.

Disadvantages of this fire extinguisher are as follows:

use made of the “piston-cylinder” pair imposes higher requirements on precision and finish in the manufacture of the mating parts, hence leading to an increase in the labor content of production;

the movable sealing of the piston is less reliable than a stationary sealing so that there is a higher probability of the fire extinguisher loosing pressure during storage;

the spring inside the head body between the valve and the sprayer exerts additional dynamic resistance to a flow of fire extinguishing powder when the fire extinguisher is in operation, thus reducing efficiency of its use.

The closest prior art analogue of the invention is represented by a locking-releasing head for a powder fire extinguisher, comprising a body provided with elements for fixing to the container of said fire extinguisher, a handle connected to the body, a locking unit provided with a rod carrying a valve fixed thereto, a control lever, a siphon tube, a pressure indicator and a spraying nozzle (U.S. Pat. No. 2,681,707 A, 22.06.1954).

In this head, the above-mentioned disadvantages are not eliminated.

### SUMMARY OF THE INVENTION

It is an object of the invention to provide a locking-releasing head for a powder fire extinguisher, which ensures obtaining a technical result consisting in reducing the labor content of production owing to making the design simpler and using progressive shaping technologies, in improving reliability of operation due to lower probability of loosing pressure during storage because of eliminating an operative movable sealing and reducing the number of joints being sealed, in improving efficiency of the head operation due to the possibility of carrying out an impulse (intermittent) operation mode allowing to control the flow rate of fire extinguishing powder, depending on the intensity of fire.

This technical result, in the locking-releasing head for a powder fire extinguisher, comprising a body provided with elements for fixing to the container of said fire extinguisher, a handle connected to the body, a locking unit provided with a rod carrying a valve fixed thereto, a control lever, a siphon tube, a pressure indicator and a spraying nozzle, is achieved by that the pressure indicator is arranged on the valve rod, in which a hole is provided to communicate the under-membrane cavity of the indicator with the under-valve cavity of the head.

The valve and the indicator membrane are integral with one another and form a hollow elastic sleeve, wherein the diameter of the flange of the rod, to which the valve portion of the sleeve defined by its wall edges is fixed, is equal to the minimum diameter of the valve seat.

The body is shaped as a thin-walled stepped cylinder integral with the handle, a neck being provided within the lower portion of the cylinder at the level of the valve to define the valve seat.

The pressure indicator is arranged coaxially in the body, the top end of the indicator being provided, at the periphery, with cylindrical projections, which can come into contact with the mating cylindrical recesses provided in the control lever.

The control lever is provided with a peephole arranged opposite to the indicator dial, and the indicator is arranged so that the dial scale can be read when viewed from the handle head.

In the proposed design of the head, the under-membrane cavity of the indicator is communicated with the container of the fire extinguisher through a hole extending along the axis of the valve rod, and the indicator itself is arranged to be disposed on the opposite end of the rod. In this case, there is no necessity whatsoever to provide a special hole in the body to receive the indicator, so that the head body gets simpler and can be made as a thin-walled cylinder.

The thin-walled body can, in its turn, be manufactured using progressive shaping technologies, such as cold sheet-metal stamping.

In doing so, the handle, the lever-to-body hinge joint element and the body itself are made integral with each other from a single blank by way of successive stamping operations. This makes the head more adaptable to streamlined production.

The valve and the membrane being integral with one another so as to form an elastic sleeve, the bottom of which serves as the indicator membrane, and the edges define the locking surface of the valve in the form of a collar that is put with an interference fit onto the lower flange of the rod when assembling the head, allows to improve reliability of sealing the head due to a reduction in the number of surfaces to be sealed. In this case, there is no necessity whatsoever to seal the joint between the membrane and the indicator body.

The shape of the elastic sleeve is maintained when pumping up the fire extinguisher owing to that the membrane is in contact with a pack of resilient washers of the indicator, and the external lateral surfaces copy the internal contours of the rod in which the elastic sleeve is disposed.

In this design of the head, the control over opening and closing the valve is effected by the lever acting directly on the indicator connected to the valve through the rod and mounted coaxially in the body.

In order to take up the force developed by the lever and distribute it advantageously, from the viewpoint of strength, along the edges of the indicator face portion made of transparent material, cylindrical projections are provided which are arranged diametrically to each other and come into contact with the mating cylindrical recesses in the lever.

The gap between the body cylinder and the lateral surface of the indicator is sealed by means of a rubber collar that is put with an interference fit onto the rod and pressed against the bottom portion of the indicator. This sealing is movable, but it can be regarded as being hermetical, and the requirements imposed on it are not very high, insofar as it performs its function only when the fire extinguisher is in operation, that is, for a very short period of time, and serves to prevent ejection of fire extinguishing powder through the gap between the body and the indicator.

Since the indicator in this position is covered with the lever, a peephole is provided in the lever opposite to the indicator dial in order to make it possible to watch the indicator readings, and the indicator itself is turned so that the scale can be read conveniently when the viewer takes the handle of the fire extinguished, that is, as viewed from the handle.

Such location of the indicator allows watching the readings when working with the fire extinguisher, without turning it, thus making the fire extinguisher more convenient in operation.

### BRIEF DESCRIPTION OF THE DRAWINGS

FIG. 1 is a sectional view of the head; and FIG. 2 is view A in FIG. 1, as turned around.

### DISCLOSURE OF THE INVENTION

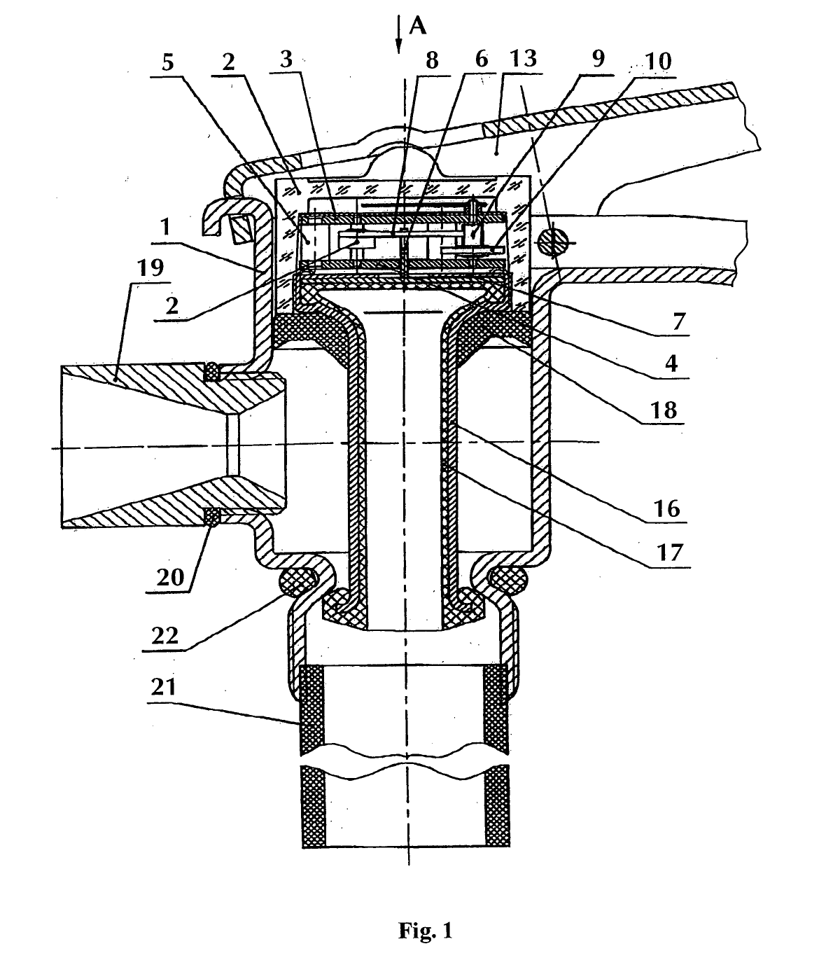

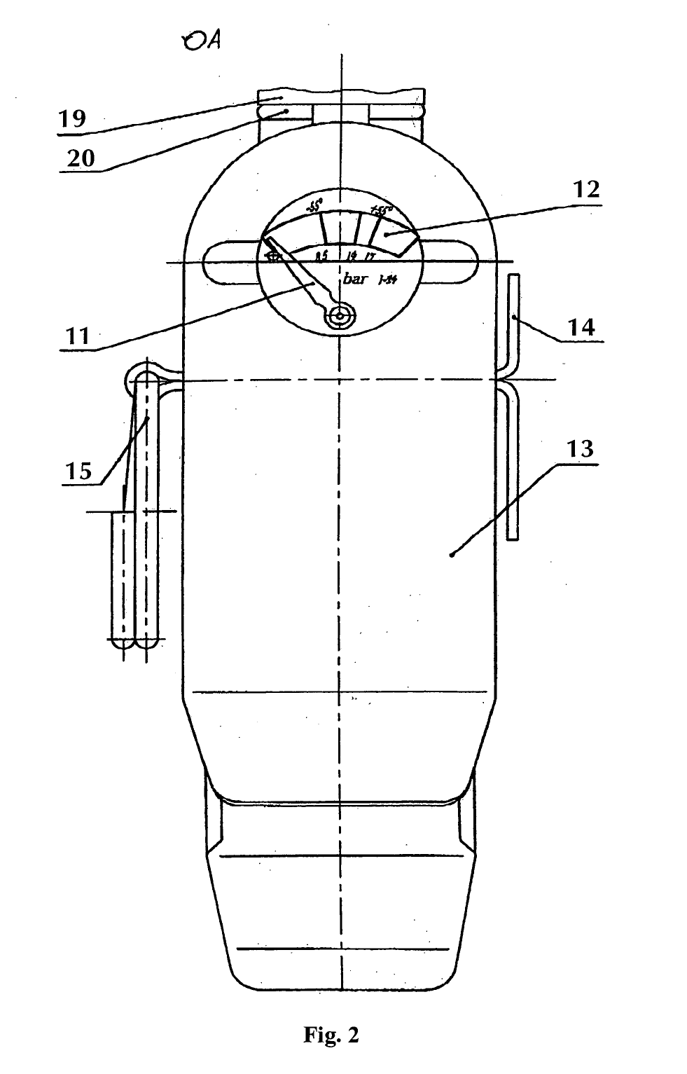

The head consists of a body 1 made by sheet-metal stamping so that it is integral with a handle and a hinge joint element (FIG. 1). In the upper portion of the cylindrical body, an indicator 2 is mounted coaxially thereto, which includes a leverage-gear mechanism consisting of upper and lower plates 3 and 4, respectively, connected to one another by means of stands 5, a double-arm lever 6 having one end thereof interacting with a stack of resilient washers 7, and the other end, with a toothed sector 8 engaged with a pinion 9 to which a spiral spring 10 is fixed. A pointer 11 is pressed onto the upper journal of the pinion to show pressure in the container of the fire extinguisher on the scale of the dial 12 mounted to the upper plate.

A body of the indicator 2 (FIG. 1) is made of transparent material to enable reading of the scale. Along the edges of the upper face end of the indicator, cylindrical projections are provided which are arranged diametrically to each other and interact with the mating cylindrical recesses of a lever 13 (FIGS. 1 and 2).

The lever is pivotally connected through a window in the beaded flange to the body 1 (FIG. 1) and locked in its initial position by a split pin 14 (FIG. 2) with a ring 15.

In the bottom portion of the indicator, a rod 16 is screwed up which is made as a tube which becomes a cup at the top portion thereof where the stack of resilient washers is placed which are held there by rolled-up edges of the cup, whereas a flange is beaded at its lower end (FIG. 1).

Inside the rod, there is an elastic sleeve 17 whose bottom serves as a membrane of the indicator that takes up the pressure of the gas pumped therein and transmits this pressure to the stack of resilient washers, and whose edges serve as a valve which seats onto a neck of the body.

This valve is put onto the rod flange, when assembling the head, in a position when the flange extends beyond the end face of the threaded portion of the body, whereupon the rod is displaced back until the valve gets seated.

On the outside, a collar 18 is put onto the rod to seal the movable connection of the indicator and the body when the fire extinguisher is in operation.

Such assembly is feasible if the diameter of the rod flange is not larger than the minimum diameter of the seat, since the assembly is carried out in the direction from top to bottom.

After this assembly is over, a nozzle 19 together with a sealing ring 20 (FIGS. 1 and 2) is screwed down into a lateral hole of the body, the hole having a bead for cutting a thread therein.

A siphon tube 21 (FIG. 1) is screwed down into the bottom portion of the body.

In order to seal the joint between the head body and the container of the fire extinguisher, a rubber ring 22 is inserted into a groove provided behind the thread.

The head operates as follows.

The ends of the split pin 14 (FIG. 2) are unbent, whereupon it is removed by pulling the ring 15 to release the lever 13 (FIGS. 1 and 2). When the lever is depressed, the indicator 2 (FIG. 1) that is connected to the rod 16 lowers down to open the valve. The fire extinguishing powder is ejected under the influence of positive pressure existing in the container of the fire extinguisher (not shown) through the siphon tube 21, the gap between the valve and the valve seat, and the nozzle 19 into the zone of a fire site. At the initial moment of the fire extinguisher operation, pressure begins to increase in the body cavity under the collar 18. Some time later, the pressure in the container gets equal to than in the cavity of the body. Insofar as the effective area of the indicator is larger than the effective area of the valve, the upward force is greater than the force to be applied by the lever to the indicator in order to open the valve, and the indicator 2 moves upwards to close the valve. After the valve gets closed, pressure is falling down rapidly in the cavity of the body 1, and the force applied to the lever 13 by the user's finger again becomes sufficient for opening the valve. Thus, the impulse operation mode is ensured for the head.

If a larger force is intentionally applied to the lever, the jet of fire extinguishing powder will flow continuously through the nozzle 19.

In order to use the fire extinguisher repeatedly, it should be recharged as follows.

The nozzle 19 (FIGS. 1 and 2) is screwed out of the lateral hole, and a special pipe union having a safety valve is screwed down instead of it, the pipe union being connected, for instance, by means of a flexible high-pressure hose to a compressor (not shown in the Fig.). The lever 13 is in a position when the valve is open. In this position, it is fixed rigidly by means of a temporary clamp (not shown in the Fig.), coupling it to the lever.

As gas is being pumped in, its pressure is taken up by the membrane as well as by the collar, thus tending to lift up the indicator, which is held in place by the locked lever.

Under the influence of the force developed by pressure, the membrane and the stack of resilient washers 7 (FIG. 7) above the membrane get deformed. As a result, the double-arm lever 6 in contact with the stack of resilient washers executes a rocking motion and turns about its axle to push the toothed sector 8 that is engaged with the pinion 9. When this occurs, the indicator pointer 11 (FIG. 2) seated on the pinion journal deviates through a predetermined angle as graduated in the dial scale units, and pressure in the container gets thus registered. As soon as the predetermined pressure is reached, the supply of air from the compressor is shut down, and the temporary clamp is then taken off from the lever and the handle. As this takes place, the valve gets seated down in the container under the influence of pressure and locks the container.

After this, the valve ensures that pressure in the cavity of the body between the valve and the collar equalizes with the atmospheric pressure, and the pipe union is then screwed out of the lateral hole, whereas the nozzle or a flexible hose with a jet (not shown in the Fig.) is put in its place. The lever is locked by the split pin, the ends of which are bent off.

The fire extinguisher is ready for operation.

When the fire extinguisher is in operation, pressure in its container is falling down, and the indicator pointer is urged by the spiral spring 10 (FIG. 1) to execute a reverse stroke. The indicator readings can be therewith watched directly when working with the fire extinguisher, if the user looks down from the top through the peephole in the lever.

### INDUSTRIAL APPLICABILITY

In the inventive head, along with high technical and economic characteristics, reliable sealing is ensured due to a reduction in the number of joints being sealed, this being very important for pumped fire extinguishers which should keep pressure for a long time. Besides, the possibility of carrying out an impulse operation mode allows to improve the economical efficiency when extinguishing a fire of any intensity due to adjusting the flow rate of fire extinguishing powder.

The tests of its prototypes have shown that the inventive head possesses high consumer properties attainable at relatively low manufacturing costs—a factor which makes it promising for full-scale production.

1. A locking-releasing head for a powder fire extinguisher, comprising a body provided with elements for fixing to the container of said fire extinguisher, a handle connected to the body, a locking unit provided with a rod carrying a valve fixed thereto, a control lever, a siphon tube, a pressure indicator and a spraying nozzle, characterized in that the pressure indicator is arranged on the valve rod, in which a hole is provided to communicate the under-membrane cavity of the indicator with the under-valve cavity of the head.

2. The head according to claim 1, characterized in that the valve and the indicator membrane are integral with one another and form a hollow elastic sleeve, wherein the diameter of the flange of the rod, to which the valve portion of the sleeve defined by its wall edges is fixed, is equal to the minimum diameter of the valve seat.

3. The head according to claim 1, characterized in that the body is shaped as a thin-walled stepped cylinder integral with the handle, a neck being provided within the lower portion of the cylinder at the level of the valve to define the valve seat.

4. The head according to claim 1, characterized in that the pressure indicator is arranged coaxially in the body, the top end of the indicator being provided, at the periphery, with cylindrical projections, which can come into contact with the mating cylindrical recesses provided in the control lever.

5. The head according to claim 1, characterized in that the control lever is provided with a peephole arranged opposite to the indicator dial, and the indicator is arranged so that the dial scale can be read when viewed from the handle head.

6. The head according to claim 2, characterized in that the pressure indicator is arranged coaxially in the body, the top end of the indicator being provided, at the periphery, with cylindrical projections, which can come into contact with the mating cylindrical recesses provided in the control lever.

7. The head according to claim 4, characterized in that the control lever is provided with a peephole arranged opposite to the indicator dial, and the indicator is arranged so that the dial scale can be read when viewed from the handle head.

8. The head according to claim 6, characterized in that the pressure indicator is arranged coaxially in the body, the top end of the indicator being provided, at the periphery, with cylindrical projections, which can come into contact with the mating cylindrical recesses provided in the control lever.
